(19) United States
(12) Patent Application Publication
(10) Pub. No.: US 2012/0198359 A1
(43) Pub. Date: Aug. 2, 2012

(54) COMPUTER IMPLEMENTED SYSTEM AND METHOD OF VIRTUAL INTERACTION BETWEEN USERS OF A VIRTUAL SOCIAL ENVIRONMENT

(75) Inventor: Nick Lossia, Chagrin Falls, OH (US)

(73) Assignee: VLoungers, LLC, Chagrin Falls, OH (US)

(21) Appl. No.: 13/356,892

(22) Filed: Jan. 24, 2012

Related U.S. Application Data
(60) Provisional application No. 61/437,319, filed on Jan. 28, 2011.

(51) Int. Cl. G06F 3/01; G09G 5/00

(52) U.S. Cl. 715/758; 345/634; 715/753

(57) ABSTRACT

A method of displaying a graphical representation of a first user in a virtual social environment includes providing an avatar representing the first user. The avatar is stored on a first database. An identifying image of the first user is provided and the identifying image is stored on a second database. The avatar is spatially coordinated with the identifying image such that the avatar and the identifying image are in fixed relationship to one another within the virtual social environment. The avatar is displayed in fixed relationship to the identifying image within the virtual social environment on a display screen.

### CROSS-REFERENCE TO RELATED APPLICATIONS

This application claims the benefit of U.S. Provisional Application 61/437,319, filed Jan. 28, 2011, which is hereby incorporated by reference in its entirety.

### TECHNICAL FIELD

The present invention relates to a computer implemented system and method of virtual interaction between users of a virtual social environment.

### BACKGROUND

Social networking is typically provided through an online service, platform, or site that focuses on social relations among different people. These people may, for example, share interests and/or activities. The people interact with one another, socially, over the Internet, such as through e-mail and instant messaging. Social networking sites allow users to share ideas, activities, events, and interests within their individual network.

### SUMMARY

A method of displaying a graphical representation of a first user in a virtual social environment includes providing an avatar representing the first user. The avatar is stored on a first database. An identifying image of the first user is provided and the identifying image is stored on a second database. The avatar is spatially coordinated with the identifying image such that the avatar and the identifying image are in fixed relationship to one another within the virtual social environment. The avatar is displayed in fixed relationship to the identifying image within the virtual social environment on a display screen.

A method of displaying a graphical representation of a user within a computer implemented system includes providing a virtual social environment. An information database is provided which includes a plurality of user accounts, where each user account respectively includes an avatar and an identifying image. The avatar of a first user account is graphically positioned within the virtual social environment. The identifying image of the first user account is graphically represented in fixed relationship to the avatar of the first user within the virtual social environment. A two dimensional representation of the virtual social environment, including the avatar and the identifying image of the first user, is displayed on a display screen.

A method of interaction between a first user and a second user in a virtual environment within a computer implemented system includes providing a virtual social environment. An information database is provided that includes a plurality of user accounts, each user account respectively including an avatar, an identifying image, and at least one user statistic. A request is received from the second user to filter the plurality of user accounts based on a selected at least one user statistic. At least one avatar and the identifying image of at least one first user of the plurality of user accounts that is based on the selected at least one user statistic is displayed on a display screen of the second user. A request is received from the second user to select one of the at least one first user of the plurality of user accounts that were displayed based on the selected at least one user statistic. A chat request is displayed on the display screen of the selected one first user to initiate a chat between the second user and the selected first user.

### BRIEF DESCRIPTION OF THE DRAWINGS

FIG. 1 is a schematic diagram of a computer implemented system for virtual interaction between users of a virtual social environment;

FIG. 2 is a schematic diagram of the system of FIG. 1;

FIG. 3 is a schematic diagram of an application server and graphical user interface of the system of FIG. 1 in communication across a network;

FIG. 4 is a schematic illustration of an exemplary home screen of the virtual social environment presenting selectable geographic locations;

FIG. 5 is a schematic illustration of an exemplary venue selection page of the virtual social environment presenting selectable venue locations;

FIG. 6 is a schematic illustration of an exemplary lounge of the selectable venue locations of FIG. 5;

FIG. 7 is a schematic illustration of the lounge of FIG. 6 illustrating a chat session; and

FIG. 8 is a schematic flow chart diagram of an algorithm for virtual interaction between users of the virtual social environment.

### DETAILED DESCRIPTION

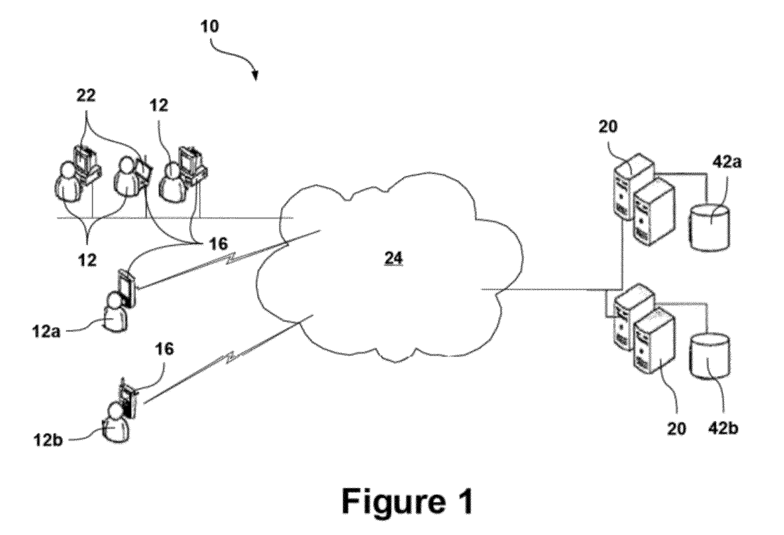

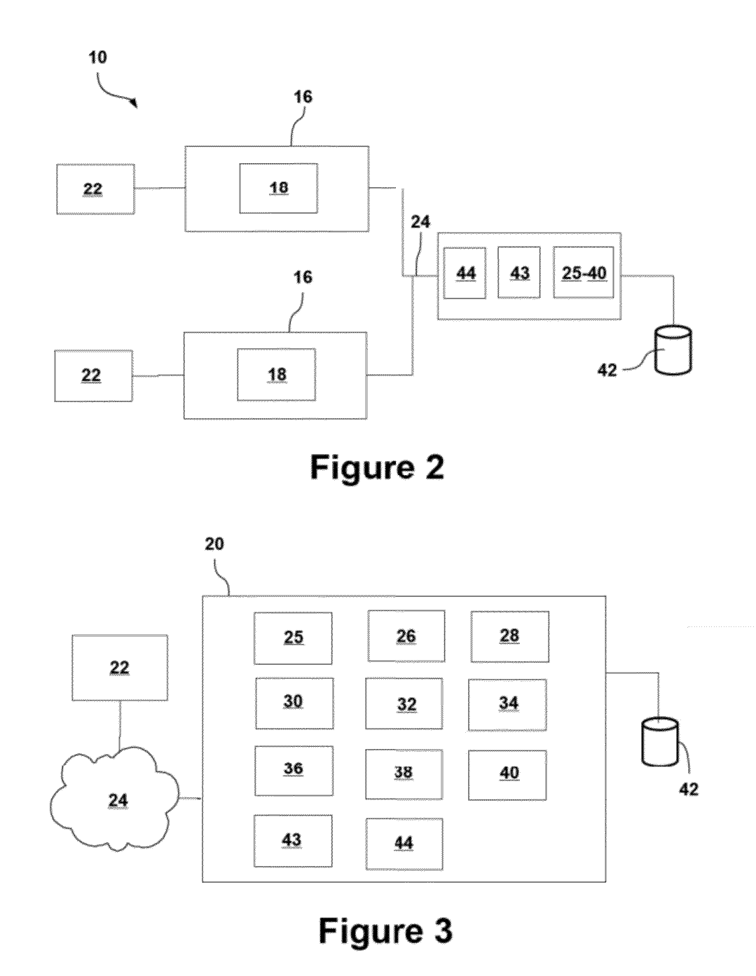

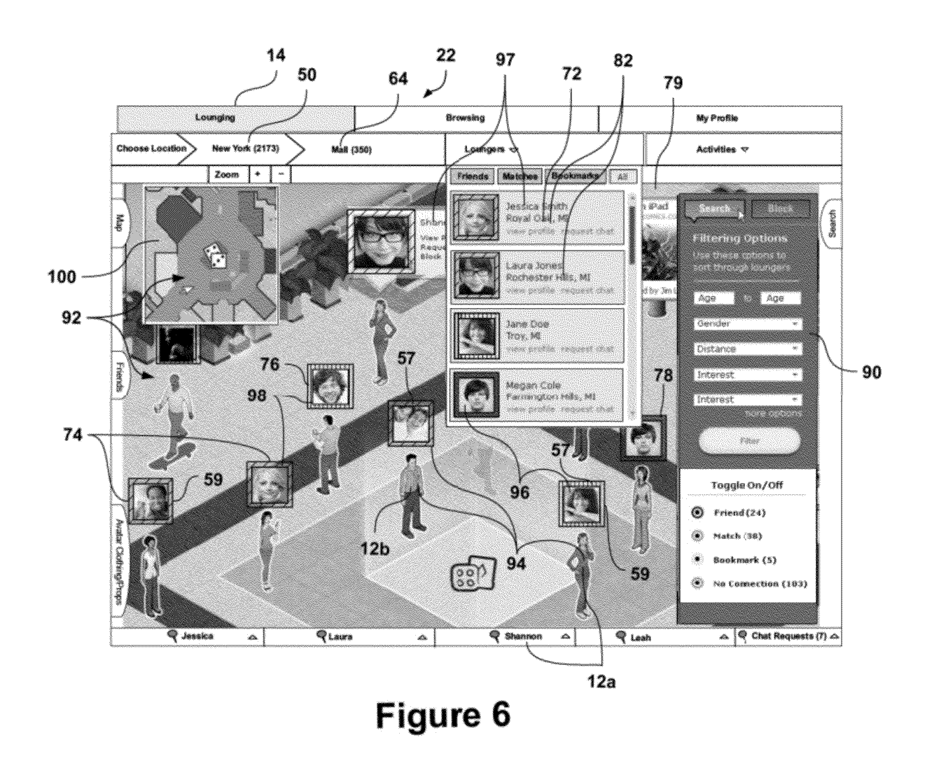

Referring to the drawings, wherein like reference numbers correspond to like or similar components throughout the several figures, FIG. 1 illustrates a computer implemented system 10 configured for virtual interaction between multiple users 12 of a virtual social environment 14 (illustrated in FIG. 6). Referring to FIG. 2, the system 10 disclosed herein includes a computing device 16 having a graphical user interface 18 (GUI), an application server 20, and a display screen 22. The GUI 18 is a visual computer environment that uses graphical images, such as icons, menus, dialog boxes, and the like, to represent files, file folders, programs, and other options to enable the multiple users 12, including at least one first user 12a and a second user 12b, to access the virtual social environment 14 via a network 24.

The application server 20 hosts the virtual social environment 14. The application server 20 is configured to retrieve, process, and present data to the GUI 18. Referring to FIG. 3, the application server 20 may include at least one of a data input module 25, location module 26, a statistics module 28, a chat module 30, a multimedia module 32, a selection module 34, interaction module 36, an advertising module 38, a shopping module 40, an information database 42, a game application module 43, and a controller 44. These modules 25-44 each represent a portion of a program that carries out a function and may be used alone or combined with other modules of the same program. The application server 20 may include these modules and/or databases or other modules and/or databases.

The data input module 25 receives any input signals received from the GUI 18, which is provided to an input field of another module. There may be a plurality of different types of data input modules 25, each configured to receive a different data input. By way of a non-limiting example, the data input may include, is not limited to, text input, number input, and location input.

The location module 26 may be used to select a geographic location 50 and/or a venue location 58 that are each provided in the virtual social environment 14. The geographic location 50 may be a virtual representation of a state, a city, and the like. The venue location 58 may be a subset of the geographic location 50. More specifically, the venue location 58 may be a virtual location within the selected geographic location 50, such as a lounge 68, a gym 70, a shopping mall 64, a beach 62, a coffee shop 60, an airport, and the like. The venue location 58 may also include, but is not limited to, private venues, seasonal venues, and the like.

The statistics module 28 determines the number of other users 12 that have also selected the same geographic location 50 and venue location 58 as the first user 12a. There is a plurality of different statistics 72 applicable to each user 12. For example, within the selected geographic location 50 and corresponding venue location 58, each user 12 may have a statistic 72 that corresponds to one or more of the following, e.g., gender, age, ethnicity, sexual orientation, marital status, and the like.

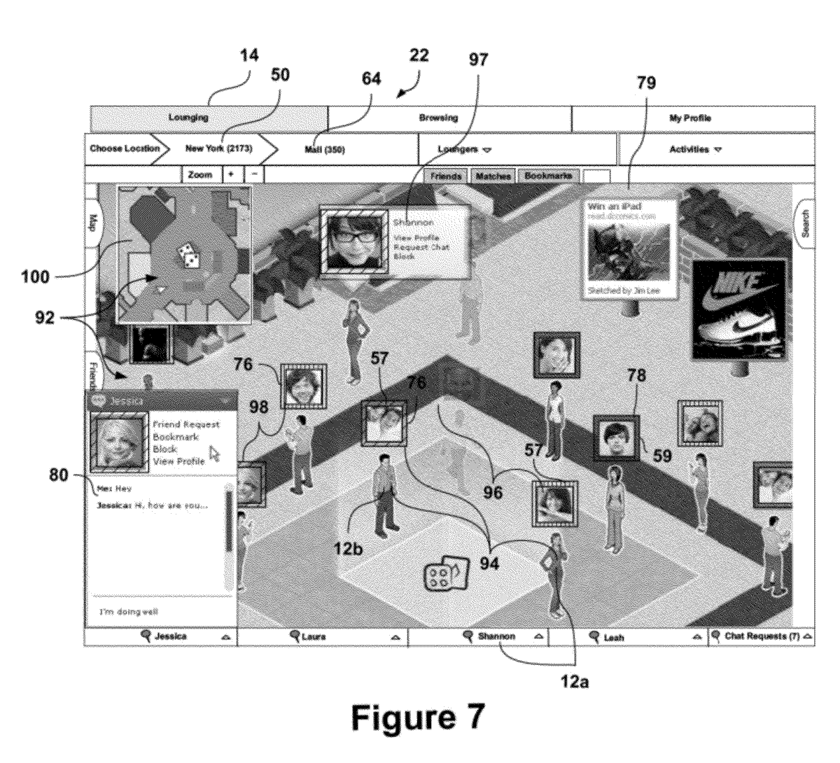

The chat module 30 presents at least one chat session 80 on the display screen 22 that is occurring between the first user 12a and at least one of the plurality of other users 12 within the virtual social environment 14, as shown in FIG. 7. Additionally, the chat module 30 may also present the user's 12 name 97, geographic location 50, and/or venue location 58 on the display screen 22. It should also be appreciated that the chat module 30 may present other information pertaining to the other users 12 involved in the chat, as known to those of skill in the art. It should be appreciated that the first user 12a does not need to be in the same venue as the second user 12b in order to initiate a chat. In one embodiment, the second user 12b may select a first user 12a to chat with by selecting a first user 12a from the drop down box shown in the lower right hand corner of the display screen 16.

The multimedia module 32 enables the controller 44 and/or one or more of the users 12 to host one or more pieces of multimedia, such that the multimedia is presented on the display screen 22 in the virtual social environment 14. The multimedia content may be games 86, music, pictures, videos, text, and the like.

The selection module 34 selects one or more of the pieces of multimedia that are provided in the virtual social environment 14 by the multimedia module 32.

The interaction module 36 enables the second user 12b and at least one of the other first users 12a to interact with one another in the virtual social environment 14. For example, the second user 12b may initiate a chat with one of the plurality of other first users 12a, ask one of the plurality of other first users 12a to play a game, and the like.

The advertising module 38 presents one or more advertising Website links and/or advertisements in the virtual social environment 14 corresponding to various retailers. For example, the advertising module 38 may present an advertising Website link in an area of one of the venue locations 58 that is viewable and/or selectable to at least one of the users 12 also present within the venue location 58.

The shopping module 40 allows the first user 12a to select at least one of the advertising Website links presented on the display screen 22 in the virtual social environment 14 and opens and displays the Website associated with the selected advertising Website link on the display screen 22.

The information database 42 stores information pertaining to the geographic locations 50, the venue locations 58, each user 12, the multimedia, the advertising Website links, and the like. The information stored in the information database 42 that pertains to each of the users 12 may include, but is not limited to, the user's 12 date of birth and/or age, gender, ethnicity, marital status, geographic location 50, sexual orientation, and/or the like. This information may be input by each of the users 12 when setting up a user 12 account for the computer implemented system 10. The computer implemented system 10 may be configured such that certain types of information may not be changed/edited after the account is initially set up, e.g., birth date, gender, and the like. The information database 42 may be a first database 42a and a second database 42b. The first database 42a may be configured to store an avatar 56 representing the users 12. The second database 42b may be configured to store an identifying image 57 of the users 12.

Referring again to FIG. 1, the plurality of users 12 participating in the virtual social environment 14 are illustrated. The users 12 include, but are not limited to the first user 12a and the second user 12b. The network 24 directly connects the users 12 to the virtual social environment 14 through a network 24 of computing and entertainment devices. In one embodiment, the Internet plays the role of the network 24.

In general, computing systems and/or devices, such as the controller 44, may employ any number of computer operating system and generally include computer-executable instructions, where the instructions may be executable by one or more computing devices 16 such as those listed above. Computer-executable instructions may be compiled or interpreted from computer programs created using a variety of well known programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks, flash memory, and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store may be included within a computing device employing a computer operating system such as one of those mentioned above, and may be accessed via a network in any one or more of a variety of manners. A file system may be accessible from a computer operating system, and may include files stored in various formats. An RDBMS may employ the Structured Query Language (SQL) in addition to a language for creating, storing, editing, and executing stored procedures, such as the PL/SQL language mentioned above.

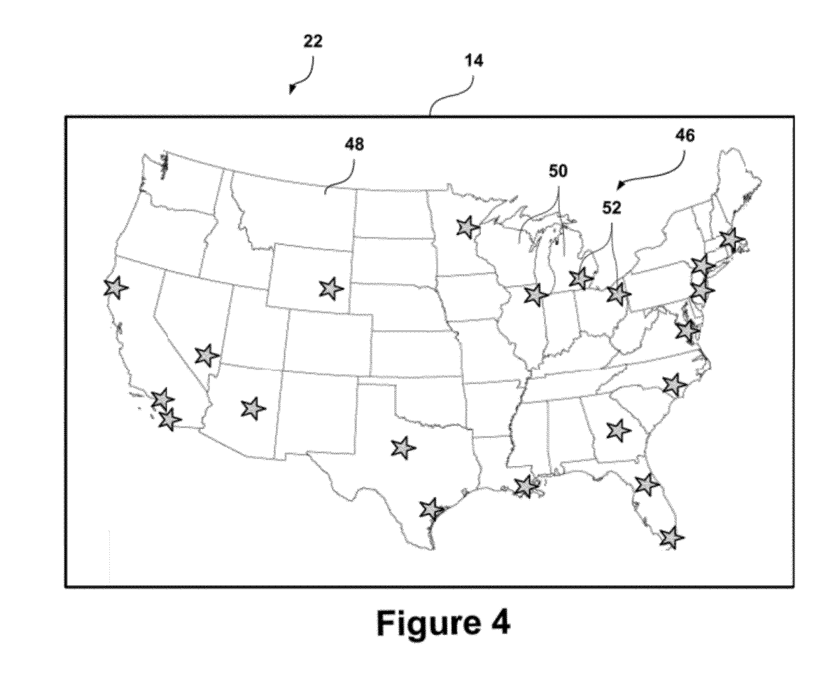

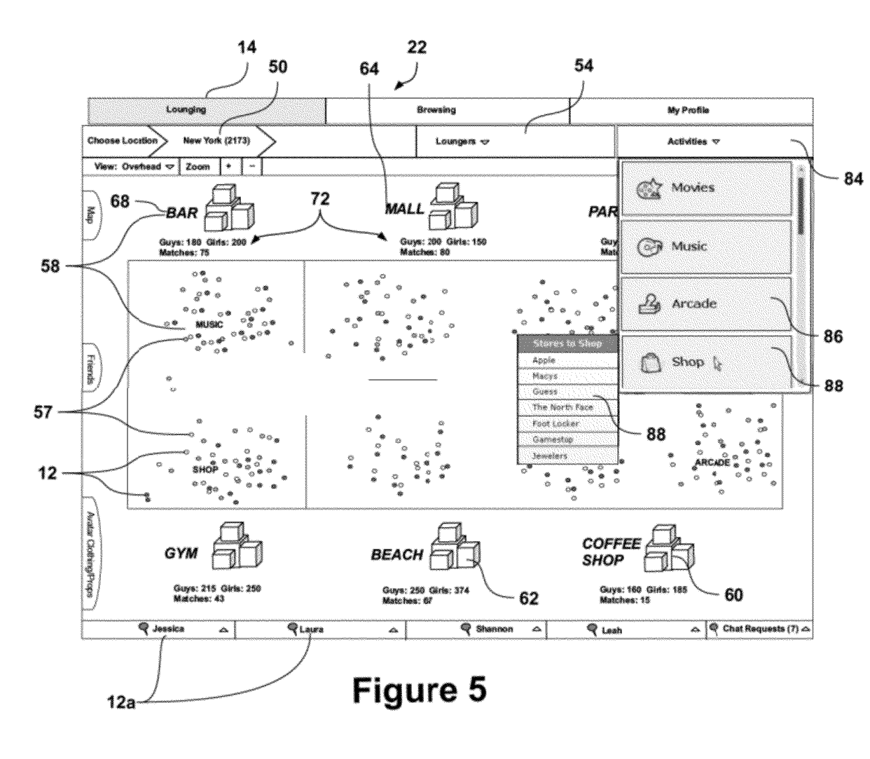

Referring to FIG. 4, a home screen 46 of the virtual social environment 14 of the system 10 is illustrated. The home screen 46 may display a map 48 that presents at least one selectable geographic location 50. For example, FIG. 4 illustrates a map 48 of the United States. A plurality of selectable geographic locations 50 are indicated by an icon 52 that is a star. If the second user 12b selects, for example, the icon 52 associated with the state of Michigan, the second user 12b will be taken to a new screen corresponding to the venue selection page 54 associated with Michigan, as shown in FIG. 5. FIG. 5 illustrates an exemplary venue selection page 54 that is associated with Michigan. The venue selection page 54 may display the avatar 56 associated with the second user 12b and a plurality of selectable venue locations 58. For example, the venue locations 58 may include, but are not limited to, virtual representations of a coffee shop 60, a beach 62, a mall 64, an airport, a lounge 68, and a gym 70. Other venue locations 58 may also be included in the venue selection page 54. The venue selection page 54 may also present statistics 72 pertaining to other first users 12a for each of the selectable venue locations 58. By way of a non-limiting example, the venue selection page 54 may present that there are currently 1,000 men and 1,200 women, with an average age of 25, in the lounge 68 of the selected geographic location 50.

The plurality of users 12 may be identified or categorized as a first category of user 74, a second category of user 76, a third category of user 78, and the like. This categorization may be based on whether or not there is a relationship established between the second user 12b and any of the other first users 12a. By way of a non-limiting example, the first category of user 74, e.g., a friend or a lounger, may be users 12 that have accepted a request sent by the second user 12b to the first user 12a to stay connected to the second user 12b at all times. The second category of user 76, i.e., a bookmark or a follower, may be users 12 that the second user 12b has identified as wanting to follow or track and that are not the first category of user 74, i.e., not a friend or lounger. The second user 12b may choose or otherwise “identify” a second category of user 76 by selecting the desired first user 12a displayed on the display screen 22. The second category of user 76 may be stored as a virtual bookmark. The third category of user 78 may be users 12 that the second user 12c is “eligible” to chat with and that are not already the first or second category of user 74, 76. Eligibility of a first user 12a may be determined based on whether that first user 12a matches with certain predefined statistical data. For example, the second user 12b may specify that they are interested in locating only those first users 12a that are married females between the age of 32 and 40. The display screen 22 would then identify those first users 12a that match that specified criteria. Eligibility may be determined based on any other criteria as known to those of skill in the art.

The display of the first, second, and third category of users 74, 76, 78 may be controlled by the second user 12b. Referring to the bottom right corner of the display screen 22 illustrated in FIG. 6, the second user 12b may select any one of the category of users 74, 76, 78 to be displayed on the display screen 22. Further, there may be other first users 12a that do not match with the second user 12b such that there is “no connection”. These first users 12a that have no connection to the second user 12b may be identified on the screen using a unique relationship identifier or may not be displayed at all. The display of these first user's 12a that have no connection to the second user 12b may be determined and controlled by the second user 12b, as illustrated in the drop down menu displayed near the top center of the screen in FIG. 6. It should be appreciated that other ways of controlling the display of first user's 12a having no connection to the second user 12b may also be used.

Also, referring to FIG. 6, the lounge 68 may display a profiling section that is configured to allow the second user 12b to selectively search or block the other first users 12a based on at least one statistic, as illustrated at 90. By way of a non-limiting example, the second user 12b may choose to search for first users 12a that are females between the age of 31 and 40, while blocking all first users 12a that have a marital status of “married”. The profiling section 90 may be limited only to those first users 12a that are also located within the same venue location 58, e.g., lounge 68, as the first user 12a. Alternatively, the profiling section 90 may allow the second user 12b to specify the geographic location 50 and/or venue location 58 of the other first users 12a as one of the statistics 72.

When the second user 12b selects any of the venue locations 58 from the venue selection page 54, the various first users 12a at the selected venue location 58 may be identified to the second user 12b based on their category. Referring to FIG. 7, an exemplary venue screen 79 for the lounge 68 is shown. The venue screen 79 may display at least one chat session 80 between the second user 12b and at least one other first user 12a, as illustrated at 80. The computer implemented system 10 may be configured such that any desired number of chat sessions 80 may be displayed at the same time on the venue screen 79. The computer implemented system 10 may also be configured such that the second user 12b may only chat with other first users 12a that are located in the same venue location 58 as the first user 12a. However, the computer implemented system 10 may also be configured such that the second user 12b may chat with other first users 12a that are located at any other venue location 58. In another embodiment, the computer implemented system 10 may be configured such that the second user 12b may remain engaged in a chat with other first users 12a while still being able to navigate their avatar 56 among and within various venue locations 58. The lounge 68 may also display a listing of the geographic location 50 and/or venue location 58 of the first category of users 74, as illustrated at 82. The listing 82 may also provide the second user 12b with the option of selecting to “call” the first category of users 74 online to chat when they are not located at the same geographic location 50 and venue 58 as the second user 12b. Additionally, the listing 82 may provide the second user 12b with the option to virtually “fly” to the geographic location 50 and venue location 58 as one of the other first category of users 74. It should be appreciated that the listing 82 is not limited to the first category of user 74, but may be any other category of user 76, 78. The lounge 68 may provide a menu of activities available to the user 12, as illustrated at 84. The menu of activities 84 may include games 86, shopping at a virtual store 88, and the like. The games 86 may be available to the second user 12b to play alone. Alternatively, the second user 12b may play with or invite at least one other first user 12a to play along as well. When the second user 12b selects a game 86 and/or a virtual store to go shopping 88 at the store 88, the second user 12b may be automatically taken to the game 86 and/or the virtual store 88. Optionally, the system 10 may be configured such that the second user 12b navigates the lounge 68 and/or venue selection pages 54 to virtually “walk” to the desired game and/or store by manipulating the avatar 56 on the venue page on the display screen 22.

The lounge 68, or other venue page, may display a floor area 92 that represents the lounge 68 where the users 12 visit virtually and socialize with one another. The floor area 92 may be a plan view, isometric view, and the like, of at least a portion of the lounge 68 of the venue location 58. When each user 12 enters the lounge 68, the users 12 may select an area of the floor area 92 of the display screen 22 to virtually place themselves at a location within the lounge 68. This means that second user 12b may place themselves next to, or away from, other specific first users 12a within the venue location 58. The users 12, including the first users 12a and the second user 12b, may be virtually represented on the floor area 92 as an identifier 94 that includes, but is not limited to, the avatar 56 and an identifying image 57. The avatar 56 and the identifying image 57 are represented as a two dimensional representation on the display screen 22. The avatar 56 may be represented for viewing on the floor area 92 of the display screen 22 in any position, i.e., front, rear, side, top, perspective, and the like. The identifying image 57 is spatially coordinated with the avatar 56 such that the identifying image 57 is displayed in a generally fixed relationship to the avatar 56 anywhere on the display screen 22. This means that the identifying image 57 remains spatially coordinated with the avatar, regardless of the location of the avatar and the identifying image 57 on the display screen 22. By way of a non-limiting example, referring to FIGS. 6 and 7, the identifying image 57 is displayed above the head of the corresponding first and/or second user 12a, 12b, regardless of whether the front or rear of the first or second user 12a, 12b is being displayed on the display screen 22. The identifying image 57 may be a photograph 96 representing the respective user 12, the user's name 97, and the like. Additionally, a relationship identifier 59 may be displayed in fixed relationship to the identifying image 57. The relationship identifier 59 is indicative of a relationship of the second user 12b with the first user 12a. The relationship identifier 59 may be a symbol 98 that is physically displayed on the display screen 22. By way of a non-limiting example, the relationship identifier 59 may be a patterned band that surrounds the relationship identifier 59, where the pattern displayed on the band correlates to one of the relationship statuses 74, 76, 78. Additionally, the relationship identifier 59 may be a color which correlates to one of the relationship statuses 74, 76, 78. For example, the first, second, and third category of users 74, 76, 78 may be identified using relationship identifiers 59 that are blue, yellow, and red, respectively. However, other colors may be used as well. The photograph 96 representing the respective user 12 may be any photograph that has been uploaded by the user 96 into the user's profile in the first database 42a. Therefore, the photograph 96 may be selectively changed by the user 18. Additionally, in other areas, outside the floor area 92 of the display screen 22, the users 12a may be displayed as having any combination of the avatar 56, the identifying image 57, and the relationship identifier 59. The symbol 98 of the relationship identifier 59 may be some type of indicator having a specified shape, size, and/or color that represents the relationship of the second user 12b to the first user 12a.

The second user 12b may physically move the corresponding identifier 94, including the avatar 56 and the spatially coordinated identifying image 57 around the floor to get closer to, or further away, from other first users 12a. The second user 12b provides an input to the system 10 which designates a direction of movement or a location on the floor where the identifier 94 should be moved to and the system 10 moves the identifier 94 in response. Additionally, if the floor area 92 is a large area that cannot easily show all of the users 12 on the display screen 22 with clarity, a venue map 100 may also be displayed, as shown in FIGS. 6 and 7. The venue map 100 may display the floor area 92 in its entirety, or at least a broader section of the floor area 92. The identifier 94 displayed on the venue map 100 to represent the users 12 may be limited to the symbol 98, or some other type of identifier 94. The symbol 98 may be limited to representing the relationship of the users 12 to the first user 12a. Additionally, in one embodiment, the profiling section 90 may be configured such that only those users 12 selected based on their matching statistics 72 are displayed on the floor area 92 and/or the venue map 100 for the venue location 58. This can help the first user 12a more easily navigate the floor area 92 of otherwise crowded venue locations 58. Alternatively, in another embodiment, a zoom feature may be provided that will allow the first user 12a to view the entire floor area 92 as a map showing all of the users 12 on the display screen 22 with clarity. In yet another embodiment, the zoom feature may be provided to zoom into the floor area 92 to view the other first users 12a closer up. In zooming into the floor area 92, the other first users 12a that are not in view of the zoomed in view are no longer shown on the display screen 22. Conversely, when zooming out of the floor area 92, other first users 12a may now come within the view and would now be shown on the display screen 22. As the floor area 92 is zoomed in or zoomed out, the represented avatars 56 and corresponding identifying images 57 remain in fixed relationship to one another.

The virtual social environment 14 displayed on the display screen 22 for the venue location 58 may be configured such that those first users 12a that are not the first, second, and/or third category of users 74, 76, 78 are hidden from the view of the second user 12b. Hiding these first users 12a that are uncategorized may make the view less crowded when a large number of first users 12a are occupying the same venue location 58 as the second user 12b. The display screen 22 may be further configured to display only the category or categories of users 74, 76, 78 that the second user 12b wants to view. By way of a non-limiting example, the second user 12b may select that only the first category of users 74 and the second category of users 76 are displayed, effectively eliminating the third category of users 78 from view. The display of the plurality of users 12 located within the venue location 58 may be configured in other ways than described herein.

Additionally, referring again to FIGS. 6 and 7, the system 10 may be configured such that the second user 12b may drag or click on a location within the venue map 100 of the venue location 58 to move to the location selected within the venue location 58. The identifier 94 that corresponds to the second user 12b would move to the newly selected location.

It should be appreciated that the floor area 92 of the venue location 58 displayed on the display screen 22 is not limited to a plan view, but may be a side view, a side perspective view, etc. The floor area 92 and the venue map 100 of the virtual social environment 14 may be displayed next to one another on the display screen 22. The floor area 92 may be displayed as being a smaller subset 64 of that which is presented in the venue map 100. As described above, the identifier 94 of each user 12 may be the avatar 56, the identifying image 57, the name 97, relationship identifier 59, and the like. Each of the users 12 may selectively choose or create their own avatar 56, which is stored within the second database 42b.

When creating their own avatar 56, each user 12 may purchase clothing and accessories for the avatar 56 online, at a store. However, it should be appreciated that the avatar 56 may be created and modified in any other way. Additionally, the users 12 may upload a photograph 96 of themselves. Also, the symbol 98 of the relationship identifier 59 corresponding to each users 12 category (i.e., first, second, or third category of user 74, 76, 78) may be displayed in association with the avatar 56 and/or identifying image 57 for each user 12 displayed in the venue room view. In the venue room view, the second user 12b may click to move within the view of another first user 12a of the venue location 58. For example, if the second user 12b wants to move closer to another first user 12a, the second user 12b may click the other first user 12a (or within a close proximity of the other first user 12a). The graphical representation of the second user 12b may move to the newly selected location.

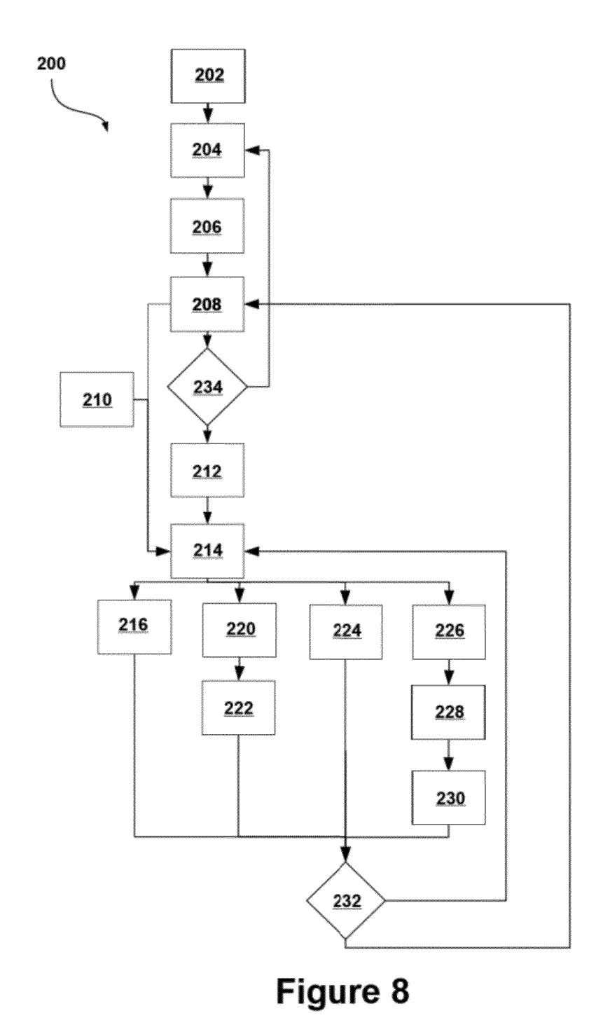

Referring to FIG. 8, an algorithm 200 may be executed by the controller 44 and includes steps 202-234.

At step 202, each second user 12b inputs their data, selects their avatar 56 to be saved on the first database 42a, and uploads at least one profile picture through the data input module 25 to the second database 42b that will act as the identifying image.

At step 204, the second user 12b logs on to the computer implemented system 10 and enters the home screen 46 of the virtual social environment 14, as shown in FIG. 4. The home screen 46 may be a location selection page that displays selectable geographic locations 50 that are indicated by the icon 52. The home screen 46 may display at least one selectable geographic location 50 in the virtual social environment 14. The selectable geographic location 50 may include a country, a state, a city, and the like. The home screen 46 is not limited to being a location selection page, but may be any other screen as well.

Additionally, the second user 12b may select their avatar and clothing for their avatar. Additional clothing and/or props for use with the avatar may be purchased, e.g., from a virtual on-line store.

At step 206, one of the selectable geographic locations 50 displayed on the home page of the display screen 22 is selected by the first user 12a. For example, a person may “travel” to New York City by selecting New York City on the homepage or location selection page of the display screen 22. As a result, the location module 26 selects the corresponding geographic location 50 from the application server 20.

At step 208, a venue selection page 54 corresponding to the selected geographic location 50 is displayed on the display screen 22. The venue selection page 54 displays at least one selectable venue location 58 within the selected geographic location 50. The selectable venue locations 58 may include the lounge 68, the library 70, the shopping mall 64, the beach 62, the coffee shop 60, the airport 66, and/or the like.

At step 210, the statistics module receives a request from the second user 12b to select first users 12a from the information database 42 that match a selected statistical profile. The first users 12a that match this selected profile are presented on the display screen 22. More specifically, the statistics module 28 selects at least one statistic pertaining to the first users 12a. The statistics 72 may be retrieved from the information database 42 by the statistics module 28. In one embodiment, the first users 12a selected may be only those first users 12a that are also present in the same geographic location 50 and/or venue location 58 as the second user 12b. The statistics 72 selected by the statistics module 28 may be configured to only display first users 12a in the same geographic location 50 and venue location 58 as the first user 12a that match the statistics 72 specified by the first user 12a. Alternatively, the statistics 72 selected by the statistics module 28 may be used to display the statistics 72 pertaining to the total number of users 12 at a particular geographic location 50 and venue location 58, as illustrated in FIG. 5. The selected venue location 58 may also present at least one statistic that pertains to the other first users 12a who have also selected the same venue location 58. As described above, the statistics 72 may pertain to the total number of other users 12 that have also selected the same venue location 58 as the first user 12a. Additionally, the statistics 72 may pertain to, but are not limited to, gender, age, ethnicity, marital status, geographic location 50, sexual orientation, etc. The statistical information pertaining to the first users 12a that have also selected the same venue location 58 may be presented on the display screen 22 interactively. More specifically, the statistical information may be presented such that the second user 12b may select or block the plurality of first users 12a based on one or more of the statistics 72. By way of a non-limiting example, the second user 12b may view the statistics 72 relating to unmarried females between the ages of 18-32.

At step 212, one of the selectable venue locations 58 is selected by the second user 12b. For example, the second user 12b may select the lounge 68 of the selected geographic location 50 as the venue location 58 to visit. Once the second user 12b selects the venue location 58, the location module 26 selects the corresponding venue location 58 from the application server 20.

The venue page corresponding to the selected venue location 58 is displayed on the display screen 22 at step 214. The venue page may present a graphical representation of the virtual social environment 14, including the graphical representation of the plurality of first users 12a who have also selected the same venue location 58 and geographic location 50 as the second user 12b. The graphical representation of the plurality of users 12 displayed on the display screen 22 may be displayed as at least one avatar 56, identifying image 57, and/or relationship identifier 59 associated with each first user 12a that also selected the same venue location 58 as the second user 12b.

At step 216, the chat module 30 is configured to present at least one chat session 80 on the display screen 22. The chat session 80 is between the second user 12b and at least one of the other first users 12a. The chat session 80 may be limited to being between the second user 12b and only those first users 12a also located at the same geographic location 50 and/or venue location 58 as the second user 12b. Alternatively, the chat session 80 may be between the second user 12b and any other first user 12a, regardless of location.

To initiate a chat, the second user 12b sends a request to the desired first user(s) 12a to initiate a chat. A request is presented to the selected first user(s) 12a who either accepts the chat request or denies the chat request. If the first user 12a accepts the chat request, the chat module 30 presents the chat session 80 on the display screen 22 of the second user 12b and the corresponding first user 12a such that a chat can occur between the two users 12a, 12b.

At step 220, the multimedia module 32 is configured such that the controller 44 and/or one or more computing devices 16 of the users 12 host one or more pieces of multimedia. As a result, the selectable multimedia is presented on the display screen 22 of the second user 12b in the virtual social environment 14 for viewing and optional selection by the second user 12b at step 222. The multimedia includes, but is not limited to, games 86, music, pictures, videos, text, and the like. At step 220, the selection module 34 selects one or more pieces of multimedia that is presented on the display screen 22 of the second user 12b, at the direction, i.e., selection, of the second user 12b.

At step 224, the interaction module 36 enables the second user 12b and at least one of the other first users 12a to interact with one another in the virtual social environment 14. Interaction may include, but is not limited to, the initiation of a request by the second user 12b with at least one first user 12a, asking the first user 12a to play a game, and the like.

At step 226, the advertising module 38 is configured to present one or more advertising Website links and/or advertisements on the display screen 22 of the second user 12b in the virtual social environment 14, corresponding to at least one retailer. The advertising module 38 may present an advertising Website link in an area of one of the venue locations 58 that is viewable and/or selectable by the second user 12b.

At step 228, the shopping module 40 allows the second user 12b to select at least one of the advertising Website links presented on the display screen 22 in the virtual social environment 14. As a result of the selection at step 228, the Website associated with the selected advertising Website link opens on the display screen 22, at step 230, providing the second user 12b with the ability to shop or peruse the Website. The link may be opened in a new window or may reuse the same window.

By way of a non-limiting example, when the selected venue location 58 is the shopping mall 64, the advertising module 38 may be configured to display a plurality of advertising Website links associated with a plurality of virtual stores. The shopping module 40 is configured to select and open the Website associated with a link that is selected by the second user 12b. The selected website may open in a separate tab, a separate window, or reuse the same window.

At step 232, when the second user 12b wants to exit the particular venue location 58, the second user 12b makes a selection, typically represented on the display screen 22, to exit and return to the venue selection page 54 that is presented at step 208. If the second user 12b further decides to exit the venue selection page 54 and return to the home screen 46, at step 234, the second user 12b makes a selection, typically on the display screen 22, to exit the venue selection page 54 and return to the home screen 46 that is presented at step 104. It should be appreciated, however, that the second user 12b is not limited to navigating among the various screens and pages of the virtual social environment 14 as described above, as any other order and method of navigation may also be used, as known to those of skill in the art.

While the best modes for carrying out the invention have been described in detail, those familiar with the art to which this invention relates will recognize various alternative designs and embodiments for practicing the invention within the scope of the appended claims.

1. A method of displaying a graphical representation of a first user in a virtual social environment comprising:
providing an avatar representing the first user;
storing the avatar on a first database;
providing an identifying image of the first user;
storing the identifying image on a second database;
spatially coordinating the avatar with the identifying image such that the avatar and the identify image are in a fixed relationship to one another within the virtual social environment; and
displaying the avatar in the fixed relationship to the identifying image within the virtual social environment on a display screen.

2. A method, as set forth in claim 1, further comprising moving the avatar and the identifying image within the virtual social environment such that the avatar and the identifying image remain in fixed relationship to one another.

3. A method, as set forth in claim 2, further comprising receiving a request to move the avatar and the identifying image within the virtual social environment; and
wherein moving the avatar and the identifying image is further defined as moving the avatar and the identifying image within the virtual social environment in response to the request to move the avatar and the identifying image such that the avatar and the identifying image remain in fixed relationship to one another.

4. A method, as set forth in claim 1, wherein displaying the avatar in the fixed relationship to the identifying image is further defined as displaying the avatar representing the first user in the fixed relationship to the identifying image of the first user within the virtual social environment on the display screen of a second user; and
further comprising displaying a relationship identifier in fixed relationship to the identifying image, wherein the relationship identifier is indicative of a relationship of the second user with the first user.

5. A method of displaying a graphical representation of a user within a computer implemented system comprising:
providing a virtual social environment;
providing an information database including a plurality of user accounts, each user account respectively including an avatar and an identifying image;
graphically positioning the avatar of a first user account within the virtual social environment;
graphically positioning the identifying image of the first user account in fixed relationship to the avatar of the first user within the virtual social environment; and
displaying a two dimensional representation of the virtual social environment, including the avatar and the identifying image of the first user, on a display screen.

6. A method, as set forth in claim 5, receiving a request to zoom the display screen to view the avatar and the identifying image in fixed relationship to one another within the virtual social environment at a plurality of zoom levels; and
displaying at least an avatar and identifying image of at least one additional user account at each of the plurality of zoom levels in response to the received request.

7. A method, as set forth in claim 5, further comprising moving the avatar and the identifying image within the virtual social environment such that the avatar and the identifying image remain in fixed relationship to one another.

8. A method, as set forth in claim 7, further comprising receiving a request to move the avatar and the identifying image within the virtual social environment; and
wherein moving the avatar and the identifying image is further defined as moving the avatar and the identifying image within the virtual social environment in response to the request to move the avatar and the identifying image such that the avatar and the identifying image remain in fixed relationship to one another.

9. A method, as set forth in claim 5, wherein graphically representing the identifying image of the first user account in fixed relationship to the avatar of the first user is further defined as graphically representing the identifying image of the first user account in fixed relationship to the avatar of the first user within the virtual social environment on a display screen of a second user; and
further comprising displaying a relationship identifier in fixed relationship to the identifying image on the display screen of the second user, wherein the relationship identifier is indicative of a relationship of the second user with the first user.

10. A method, as set forth in claim 5, wherein providing an information database is further defined as providing an information database including a plurality of first user accounts, each first user account respectively including an avatar, an identifying image, and information, the information including at least one of a date of birth, an age, a gender, an ethnicity, a marital status, a geographic location, a sexual orientation, and a relationship of the first user to a second user; and
further comprising receiving a request from the second user to identify at least one first user that is logged on to the computer implemented system based on at least one of the date of birth, the age, the gender, the ethnicity, the marital status, the geographic location, the sexual orientation, and the relationship to the second user;
wherein displaying a two dimensional representation is further defined as displaying a two dimensional representation of the virtual social environment on a display screen of the second user, including only the avatar and the identifying images of the plurality of first users that are logged on to the computer implemented system and that were identified by the second user.

11. A method, as set forth in claim 10, wherein providing a virtual social environment is further defined as providing a venue within a virtual social environment; and
wherein displaying a two dimensional representation is further defined as displaying a two-dimensional representation of the virtual social environment on a display screen of the second user, including only the avatar and the identifying images of the plurality of first users that satisfy filtering criteria, the filtering criteria including:
the first users that are logged on to the computer implemented system;
the first users that selected the venue location within the virtual social environment; and
the first users that were identified by the second user.

12. A method, as set forth in claim 11, wherein the relationship identifier indicates that the relationship is one of the first category of user and the second category of user.

13. A method, as set forth in claim 10, wherein the relationship of the first user to the second user is one of a first category of user and a second category of user.

14. A method, as set forth in claim 11, further comprising displaying at least one of an advertisement and a game in the virtual social environment on the display screen of the second user.

15. A method of interaction between a first user and a second user in a virtual environment within a computer implemented system comprising:
providing a virtual social environment;
providing an information database including a plurality of user accounts, each user account respectively including an avatar, an identifying image, and at least one user statistic;
receiving a request from the second user to filter the plurality of user accounts based on a selected at least one user statistic;
displaying on a display screen of the second user at least one of the avatar and the identifying image of at least one first user of the plurality of user accounts based on the selected at least one user statistic;
receiving a request from the second user to select one of the at least one first user of the plurality of user accounts that were displayed based on the selected at least one user statistic; and
displaying a chat request on the display screen of the selected first user to initiate a chat between the second user and the selected first user.

16. A method, as set forth in claim 15, further comprising receiving an acknowledgement of the chat request from the selected first user;
wherein the acknowledgement is one of an acceptance of the chat request and a denial of the chat request.

17. A method, as set forth in claim 16, further comprising displaying a chat window on the display screen of each of the second user and the selected first user.
